(19) United States
(12) Patent Application Publication
(10) Pub. No.: US 2009/0254940 A1
(43) Pub. Date: Oct. 8, 2009

(54) SYSTEMS AND METHODS FOR DIRECTING CUSTOMERS TOWARD HELPFUL INFORMATION

(75) Inventors: Dave Kummer, Highlands Ranch, CO (US); Carol Bonetti, Castle Rock, CO (US)

Correspondence Address: INGRASSIA FISHER & LORENZ, P.C. (ES), 7010 E. COCHISE ROAD, SCOTTSDALE, AZ, 85253, US

(73) Assignee: EchoStar Satellite, LLC, Englewood, CO (US)

(21) Appl. No.: 12/061,515

(22) Filed: Apr. 2, 2008

(51) Int. Cl. H04N 5/445

(52) U.S. Cl. 725/38

(57) ABSTRACT

Systems and methods direct a customer using an appliance coupled to a display toward received information. An input is received from the customer at the appliance, and a period of relative non-use is identified. In response to the period of relative non-use, the appliance is tuned to an informational channel to thereby present the received information to the customer on the display.

### TECHNICAL FIELD

The present invention generally relates to systems and methods for directing customers toward information, and more particularly relates to systems and methods for providing information to television content customers via a set-top box or other appliance.

### BACKGROUND

Most television viewers now receive their television signals through a content aggregator such as a cable or satellite television provider. In the typical instance, encoded television signals are sent via a cable or wireless data link to the viewer's home, where the signals are ultimately decoded in a set-top box or other appliance. The decoded signals can then be viewed on a television or other appropriate display as desired by the viewer.

The broadcast transmission model works very well for delivering television content. Often, however, it can be difficult for a content aggregator to direct the customer's attention to helpful information. The aggregator may send announcements via regular or electronic mail, for example, but many consumers routinely ignore such correspondence. Moreover, direct mailings can be subject to delays, thereby making such techniques inappropriate for providing real-time or other current information.

Many aggregators now provide a customer information channel as part of the delivered television content. Often the information channel is provided at a relatively prominent place in the channel lineup (e.g., channel one), or at a channel that is commonly selected as a default (e.g., again, channel one) when the customer's set-top box or other viewing appliance restarts following a power-off or other reset condition. Resets are generally relatively rare occurrences, however, and customers in practice rarely tune to the informational channel on their own volition. While the set-top box could be configured to require the user to view the informational channel periodically, this could be seen as annoying or intrusive by many consumers.

As a result, it is difficult at present for content providers or aggregators to direct customers to additional information, even when the information is helpful to the customer. It is therefore desirable to create systems and techniques for directing customers of television content toward helpful information. These and other desirable features and characteristics will become apparent from the subsequent detailed description and the appended claims, taken in conjunction with the accompanying drawings and this background section.

### BRIEF SUMMARY

In various exemplary embodiments, systems and methods direct a customer using an appliance coupled to a display toward received information. In one embodiment, an input is received from the customer at the appliance, and a period of relative non-use is identified. In response to the period of relative non-use, the appliance is tuned to an informational channel to thereby present the received information to the customer on the display.

Other embodiments relate to a system for directing a customer viewing a display toward received information from a content aggregator. The system comprises any means for receiving the received information, and any means for receiving an input from the customer. The system further includes any means for processing the input from the customer to thereby identify a period of relative non-use, and, in response to the period of relative non-use, to select an informational channel to thereby present the received information to the customer on the display.

Still other embodiments relate to a system for presenting received information on a display for a customer. The system includes a receiving interface configured to receive the received information and a user interface configured to receive inputs from a customer. A processor is configured to receive the inputs from the user interface and, in response to a period of relative inactivity by the customer, to select an informational channel for presentation on the display to thereby present the received information to the customer.

Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a diagram of an exemplary system for providing information to a customer via a set-top box or similar appliance; and

FIG. 2 is a flowchart of an exemplary technique for directing customers toward an informational channel.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

According to various exemplary embodiments, customers are directed toward received information after a period of relative non-use of the set-top box or other appliance. That is, after a prolonged period wherein little or no input is received from the customer and/or any ensuing standby period, the appliance tunes to an informational channel that can be presented to the user. The informational channel may be produced by the content aggregator, or the appliance itself may format an informational channel that includes information received from the aggregator in any manner. The various embodiments described herein allow the customer's attention to be directed toward the informational channel at times during which changes in focus are likely to be accepted by the customer. By tuning the informational channel after a period of relative non-use, for example, the customer is unlikely to object to the change and may in fact appreciate the new information being presented.

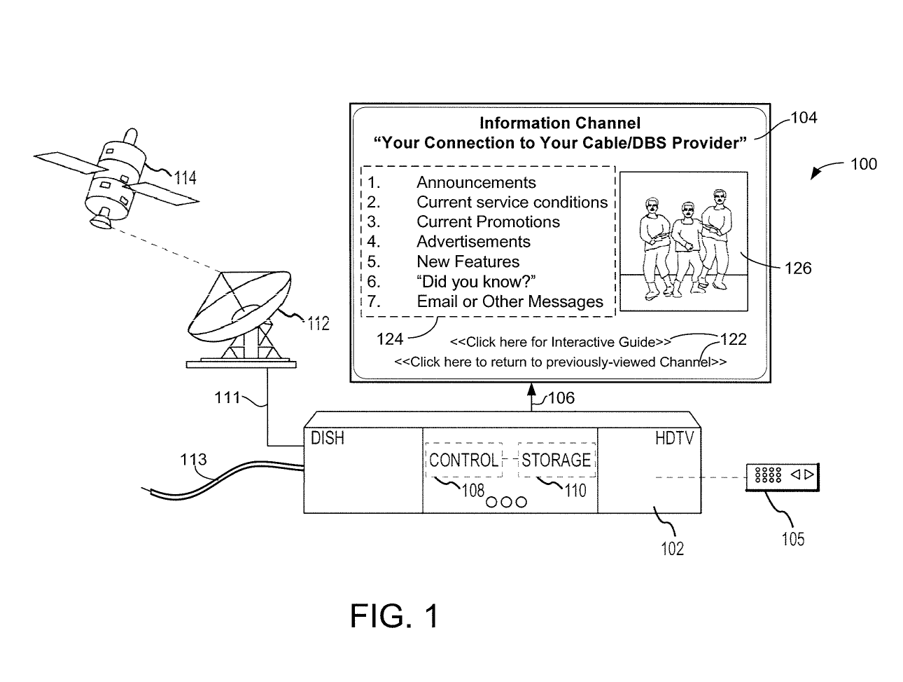

Turning now to the drawing figures and with initial reference to FIG. 1, an exemplary system 100 for providing received content to a customer suitably includes a set-top box or other appliance 102 that receives transmitted content and that provides an output signal 106 to a display 104 in response to inputs received via a remote control or other user interface 105. In various embodiments, the system 100 is configured to select and present an informational channel (e.g., using signal 106) on display 104 in response to a period of relative non-use of appliance 102. Such a period of non-use may be identified, for example, when little or no user inputs are received over an appropriate period of time.

Appliance 102 is any set-top box (STB) or other device capable of receiving television or similar content from an aggregator and of generating a suitable output signal 106 in response to user inputs. In various embodiments, appliance 102 is configured with one or more conventional interfaces to receive signals 111 received from a wireless antenna 112, which in turn may receive wireless programming and other content from a satellite 114 and/or any terrestrial-based transmitter. Alternatively or additionally, appliance 102 may include any number of interfaces to cable television signals and/or any other wired inputs 113. Other sources of television inputs that may be present in other embodiments include high or low definition broadcast sources, wireless or wired transmissions using any sort of broadcast, point-to-point or other transmit schemes, closed circuit television signals in any format, and/or other sources as appropriate. Many types of wired and wireless interfaces to appliances 102 are widely known, and any presently-known or subsequently developed interfaces may be used in various equivalent embodiments.

Appliance 102 includes any sort of user interface 105 as appropriate. In many embodiments, a primary interface to appliance 102 is a remote control or similar wireless interface that operates using any conventional infrared (IR) or other radio frequency (RF) spectra. In various embodiments, appliance 102 additionally or alternatively includes any number of buttons, dials, or other input devices provided in the housing of appliance 102 itself. Such buttons may include controls for power on/off, channel or volume selection, and/or other features as appropriate. Many types of remote and non-remote control devices are well-known, and any may be readily adapted to the techniques and systems described herein.

In a typical embodiment, appliance 102 includes any sort of processing or control circuitry 108, as well as associated data storage 110. Various embodiments of processor 108 include any sort of microcontroller or microprocessor executing any form of software code. Data storage 110 may include any sort of digital memory (including any sort of read only memory, random access memory, flash memory and/or the like) and/or any sort of mass storage device, including any sort of disk drive or other magnetic, optical or other storage.

In operation, appliance 102 is able to receive television programming via any wired or wireless connection (e.g. interfaces 111 and 113 in FIG. 1) and to direct imagery presented to the customer on display 104 in response to inputs received via user interface 105. Imagery presented on display 104 is directed using any number of control signals 106 in any digital or analog format compatible with display 104. This operation generally takes place under the control of any appropriate hardware, software and/or firmware within appliance 102. In a typical embodiment, software or firmware instructions for carrying out the various features provided by appliance 102 are stored in data storage 110 for execution by processor 108 as appropriate.

In the embodiment shown in FIG. 1, display 104 is shown presenting an exemplary informational channel screen for the viewer. This informational screen may be presented in any manner. The screen may be a conventional television channel, for example, that is simply presented on display 104 essentially as received from the content aggregator. Such channels may be produced by the content aggregator itself, or equivalently by the aggregator's licensee or other affiliate, to include information that is helpful to the consumer in any way.

In other embodiments, the informational channel provided in signal 106 to display 104 need not be produced at a remote aggregator, but may be generated locally based upon information received from the content aggregator. Such information may be received in real-time, or may be transmitted across any wired or wireless transmission medium (e.g., media 111 and/or 113) on a batch or other temporal basis. Locally-generated content may include any sort of graphical, textual, video and/or other imagery. In various embodiments, the presented informational channel may include a link or “hot” button 122 that allows the customer to quickly tune to an electronic program guide, to the last channel viewed, or to any other channel as desired.

In still further embodiments, an informational channel produced by a content aggregator can be supplemented with locally-generated content in any manner. The imagery shown in FIG. 1, for example, shows an audio/visual window 126 as well as more static content that includes textual information 124, hot links 122 and/or other features as appropriate. In various embodiments, links 122 and/or static text 124 may be generated locally by appliance 102, with audio/visual content 122 being received from a content aggregator. Alternatively, static and dynamic content can be generated by the content aggregator, with the resulting imagery contained within the informational channel received by appliance 102 via interfaces 111 and/or 113. In a further embodiment, content presented in the informational channel follows two or more content streams, with each stream having an associated static portion and an audio/visual portion. As an example, one stream could present an advertisement for a particular program, channel, product, service or the like, while another stream is more informational (e.g., “how to use the appliance”, service information, real-time information and/or the like). In such embodiments, the static portion from one stream can be used as a “wrapper” or other interface element that is displayed in conjunction with dynamic content (e.g., audio/visual content) from the other stream. That is, static content for one stream is presented at the same time as dynamic content from the other stream. In the exemplary embodiment shown in FIG. 1, for example, the customer is able to view service announcements, to select a link 122, or to obtain other information while an advertisement or other message is played in window 126. In a further embodiment, a link or other input could be provided to allow appliance 102 to take an action related to the static or dynamic content provided in any content stream. As an example, an input in the static content could allow a viewer to program a DVR to record an advertised program, to instruct the appliance to tune to the advertised program at the appropriate time, to play a received audio or video clip with additional information, and/or to take any other action as appropriate. Content from the two streams may be optionally swapped at any interval in some embodiments so that static and dynamic content from each stream is presented to the customer over any appropriate time interval. Again, the particular content of the informational channel may vary widely from embodiment to embodiment.

Information provided by the informational channel may include any received information that is of interest to the customer. Such information may vary widely from embodiment to embodiment, and only a few examples are provided herein. Such information may include, for example, announcements of upcoming events, such as programming or other service changes or new product/service features. Other types of information that could be provided include information about system status, service interruptions, outages, or other issues. Still other embodiments may provide advertisements of any form (including video or still imagery), and for any product or service. Such advertisements could promote products or services offered by the content aggregator (e.g., a device or programming package), and/or any other party. New programming offers could be described, for example, as could any special offers, free viewing periods and/or other marketing information as appropriate. Other embodiments may provide information on configuring or maintaining new products or services, bits of information about current product or service offerings (e.g., “Did you know that your remote control can be used with your DVD player?”), or to provide access to individualized or system-wide messages of any sort.

By displaying received information in the informational channel, real-time (or at least relatively current) information can be presented to the customer in a convenient manner. Current information of benefit to consumers might include system status information, weather, news, and/or simply the time or date. Other embodiments need not present information that is updated in real-time or that is time based, but may still provide received information from the content aggregator on a real-time basis. In embodiments wherein the informational channel is simply received from the content aggregator, for example, the channel information may be received in real-time even though the information presented may be previously recorded or otherwise delayed.

As noted above, customers can be directed to the informational channel at times when such direction is minimally obtrusive. One such time is when the appliance 102 has been relatively inactive for a prolonged period of time, when the consumer can be assumed to have directed his or her attention away from display 104. Upon return, then, the consumer can be presented with the informational channel without significant effect.

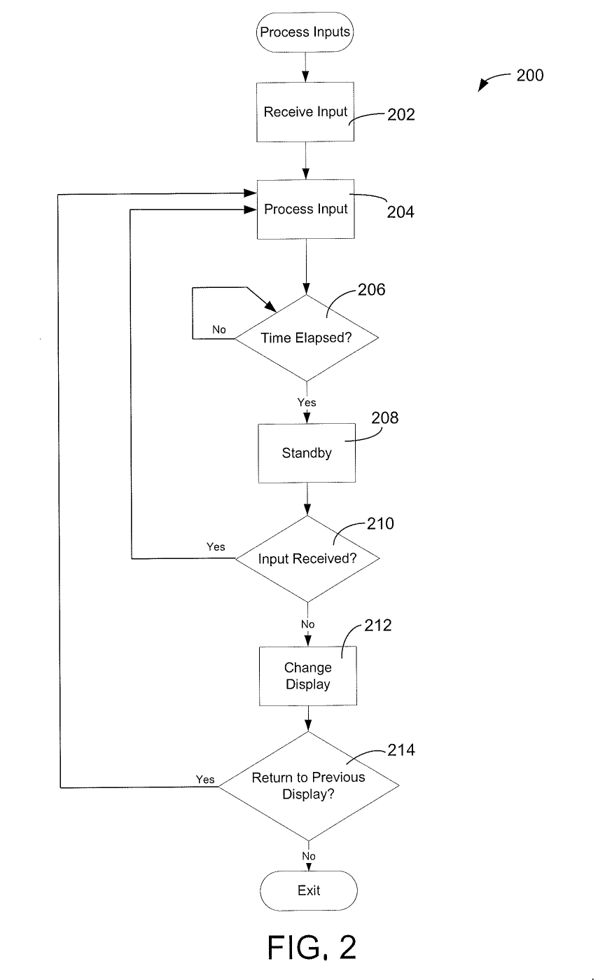

Referring now to FIG. 2, an exemplary method 200 for presenting information in an EPG display suitably includes the broad steps of receiving an input from the consumer at the appliance (step 202), identifying a period of relative non-use (step 206), and then tuning the appliance to an informational channel (step 212) in response to the period of relative non-use. The logic used to control and execute the various steps shown in FIG. 2 may be implemented in any sort of hardware, software and/or firmware. For example, each of these steps may be computer-implemented by processing circuitry 108 residing within appliance 102. In such embodiments, controller 108 typically responds to software or firmware instructions that may be stored in any source or object code format in storage 110, and/or in any other location as appropriate.

As noted above, inputs may be received at appliance 102 in any manner (step 202). In various embodiments, inputs from the customer are received via user interface 105, which may include any sort of remote and/or non-remote control features. In various embodiments, user inputs may include instructions to change channels, volume or any other parameters associated with television viewing as appropriate. Appliance 102 receives the inputs at an appropriate interface (e.g. an IR or other RF interface to a remote control), and processes the inputs using any conventional techniques (step 204).

When few or no inputs are received over a period of time (step 206), the appliance may identify a period of relative non-use. “Relative” in this sense simply means that the one aspect of usage of appliance 102 is less active than usual. Relative non-use may relate to any particular parameter (e.g. channel changing) while ignoring other parameters (e.g. volume changes) in some embodiments. In some embodiments, for example, the period of relative non-use may be identified when a user has not changed the channel viewed for some time, even if volume adjustments (or volume muting) may have occurred more recently. In other embodiments, the period of relative non-use is identified when no inputs have been received from the user for an appropriate period of time. Further, “relative” non-use may mean that certain channels are not considered when evaluating a period of non-use. Some customers, for example, may leave music or “radio” channels playing without significant input over a period of several hours. This prolonged viewing of certain channels may not constitute “non-use” in some embodiments.

The appropriate time may vary considerably from embodiment to embodiment. In some implementations, for example, the period of relative non-use may extend for any time ranging from minutes to hours, depending on user habits and preferences. A period of several (e.g., two to five) hours may be used in some embodiments. In other embodiments, the appropriate time is configurable to be set by the customer or any other party.

In various embodiments, appliance 102 enters a “sleep” or “standby” mode when a period of relative non-use is identified. In the standby mode, the screen of display 104 may be dimmed or otherwise darkened to prevent “burn in” of a screen image, to conserve energy, and/or to avoid disturbing a user who may have fallen asleep or otherwise lost interest in the previous programming. Audio may be similarly silenced or reduced in volume as appropriate and desired. Standby mode is not required in all embodiments, but may be a helpful feature in many practical implementations.

In embodiments that include standby mode 208, this mode may be exited in any manner. A button press or other input received from user interface 105 (step 210), for example, could indicate that the customer no longer intends for appliance 102 to remain in standby mode. Hence, any button press or other input may be used to indicate the end of standby mode as desired.

Upon exiting from standby mode, then, display 104 may be adjusted to present the informational channel to the customer (step 212). The channel may be presented in any manner, such as by tuning to a particular channel received via connections 111 and/or 113, by locally generating imagery containing received information for display on the tuned channel, or in any other manner.

In other embodiments, the informational channel may be presented in response to the viewer turning display 104 “on” or “off”, without regard to whether the appliance 102 was previously in a standby mode. That is, the period of relative non-use may equivalently refer to a period of time in which the device is powered off. In such embodiments, a universal or other remote associated with appliance 102 can be programmed to notify the appliance 102 when the consumer turns display 104 on or off. This notification may be sent to appliance 102 in addition to the signal sent to display 104. Generally, the power signal for display 104 is represented as a toggle-type signal that may not clarify whether display 104 is on or off. If display 104 is powered off, however, the customer will not typically care if the informational channel (or any other channel) is tuned by the appliance 102. As a result, the informational channel can be tuned whenever display 104 is turned on or off (i.e., whenever the power toggle signal is received) to ensure that the customer views the appropriate channel when display 104 is turned on.

After the informational channel is presented on display 104, the customer may be prompted with a message that allows rapid tuning of the previously-tuned channel (or any other channel, such as a program guide or the like) by depressing a button, or taking another convenient action with user interface 105 (step 214). Such prompting may be locally generated to overlay received content, and/or may be incorporated into a generated imagery presented to display 104 in signal 106. This feature, while optional, makes the tuning of the informational channel even less obtrusive, thereby providing improved convenience to the customer.

In practice, then, communications between a satellite or cable television aggregator and a customer can be improved though the use of an informational channel that can be tuned following a period of relative non-use of the set-top box or other appliance 102. As the appliance identifies a period of relative non-use and/or recovers from a standby mode, for example, the informational channel can be tuned to draw the customer's attention to the received information presented.

While at least one exemplary embodiment has been presented in the foregoing detailed description, it should be appreciated that a vast number of alternate but equivalent variations exist. Although the systems and techniques described herein are frequently described with respect to satellite-based implementations, for example, similar concepts could be readily applied with cable, telephone, wireless and/or any other methods of delivery. Similarly, although the particular informational channel referenced herein often relates to information regarding a satellite or cable television content aggregator, other types of advertisements or informational notices could also be provided based upon any factors. Again, the concept of providing an advertisement or other received information following a period of relative non-use can be broadly applied across a wide range of equivalent embodiments.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A method of directing a customer using an appliance coupled to a display toward received information, the method comprising:
receiving an input from the customer at the appliance;
identifying a period of relative non-use of the appliance following the input from the customer; and
in response to the period of relative non-use, tuning the appliance to an informational channel to thereby present the received information to the customer on the display.

2. The method of claim 1 further comprising entering a standby mode following the period of relative non-use.

3. The method of claim 2 wherein the display is changed to provide the information to the customer upon a recovery from the standby mode.

4. The method of claim 3 wherein the recovery from the standby mode is performed in response to a subsequent input received from the user after the period of relative non-use.

5. The method of claim 1 further comprising prompting the customer for a response at an end of the period of non-use, and entering a standby mode if the response is not provided.

6. The method of claim 1 further comprising prompting the customer to return to a previously-viewed channel after changing the display.

7. The method of claim 1 wherein the informational channel is produced by a content aggregator that transmits the informational channel to the appliance.

8. The method of claim 7 wherein the content aggregator is one of a satellite television provider, a cable television operator, and a telephone company.

9. The method of claim 1 wherein the period of relative non-use is associated with a power signal transmitted to the display.

10. The method of claim 1 further comprising generating imagery presented on the display when the informational channel is tuned, wherein the imagery comprises the received information.

11. A system for directing a customer viewing a display toward received information from a content aggregator, the system comprising:
means for receiving the received information;
means for receiving an input from the customer; and
means for processing the input from the customer to thereby identify a period of relative non-use, and, in response to the period of relative non-use, to select an informational channel to thereby present the received information to the customer on the display.

12. The system of claim 11 wherein the informational channel is produced by the content aggregator.

13. The system of claim 12 wherein the content aggregator is one of a satellite television provider, a cable television provider and a telephone company.

14. A system for presenting received information on a display for a customer, the system comprising:
a receiving interface configured to receive the received information;
a user interface configured to receive inputs from a customer; and
a processor configured to receive the inputs from the user interface and, in response to a period of relative inactivity by the customer, to select an informational channel for presentation on the display to thereby present the received information to the customer.

15. The system of claim 14 wherein the informational channel is produced by a content aggregator to comprise the received information.

16. The system of claim 15 wherein the content aggregator is one of a satellite television provider, a telephone company and a cable television provider.

17. The system of claim 14 wherein the processor is further configured to generate imagery presented on the display when the informational channel is tuned, wherein the imagery comprises the received information.

18. The system of claim 14 wherein the received information comprises real-time information.

19. The system of claim 14 wherein the received information comprises an advertisement.

20. The system of claim 14 wherein the informational channel comprises a first content stream comprising a first portion of the received information and a second content stream comprising a second portion of the received information.

21. The system of claim 20 wherein the first portion of the received information comprises dynamic content and the second portion of the received information comprises static content, and wherein the first and second content streams are presented simultaneously on the display.

22. The system of claim 21 wherein the second content stream further comprises an input interface configured to direct the appliance to take an action in response to the inputs received from the customer.
